(19) United States
(12) Patent Application Publication
(10) Pub. No.: US 2018/0155601 A1
(43) Pub. Date: Jun. 7, 2018

(54) FLUID FORMULATIONS FOR CLEANING OIL-BASED OR SYNTHETIC OIL-BASED MUD FILTER CAKES

(71) Applicant: Baker Hughes Incorporated, Houston, TX (US)

(72) Inventors: Johnathan J. Brege, Richmond, TX (US); Gianna A. Pietrangeli, Houston, TX (US); Alexander J. McKellar, The Woodlands, TX (US); Lirio Quintero, Houston, TX (US); Ana Forgiarini, Merida (VE); Jean-Louis Salager, Merida (VE)

(73) Assignee: Baker Hughes Incorporated, Houston, TX (US)

(21) Appl. No.: 15/884,005

(22) Filed: Jan. 30, 2018

Related U.S. Application Data
(62) Division of application No. 14/478,510, filed on Sep. 5, 2014.
(60) Provisional application No. 61/880,723, filed on Sep. 20, 2013.

(51) Int. Cl. C09K 8/04; C09K 8/035; C09K 8/524

(52) U.S. Cl. CPC C09K 8/04; C09K 8/035; C09K 8/524

(57) ABSTRACT

A treatment composition may contact an oil-based mud (OBM) filter cake formed over at least part of a wellbore for cleaning the filter cake by incorporating more oil and/or filter cake particles into the treatment composition as compared to an otherwise identical filter cake absent the treatment composition. The treatment composition may include, but is not limited to, a surfactant, an aqueous-based fluid, an agent, an optional second acid, and combinations thereof. The agent may be or include long chain alcohols, phenol derivatives, fatty esters, a first acid, and combinations thereof. The first acid may be or include a diacid. The diacid may be a polycarboxylic diacid, such as but not limited to [N-(1,2-dicarboxyethylene)D,L asparagine acid] (IDS), polyaspartic acid (DS), ethylenediamine-disuccinic acid (EDDS), [N,N-bis(carboxylmethyl)L-glutamic acid] (GLDA), methylglycinediacetic acid (MGDA), salts thereof, derivatives thereof, and combinations thereof. The tetraacid may be ethylenediaminetetraacetic acid (EDTA), hydroxyl-ethylenediaminetetraacetic acid (HEDTA), and the like.

### CROSS-REFERENCE TO RELATED APPLICATION

This application is a divisional of U.S. patent application Ser. No. 14/478,510 filed Sep. 5, 2014, which claims the benefit of U.S. Provisional Patent Application No. 61/880,723 filed Sep. 20, 2013, both of which are incorporated by reference herein in their entirety.

### TECHNICAL FIELD

The present invention relates to methods and treatment compositions for incorporating more oil and/or filter cake particles into the treatment composition, and more specifically relates to a treatment composition having a surfactant, an aqueous-based fluid, and an agent selected from the group consisting of long chain alcohols, phenol derivatives, fatty esters, a first acid, and combinations thereof.

### BACKGROUND

Drilling fluids used in the drilling of subterranean oil and gas wells along with other drilling fluid applications and drilling procedures are known. In rotary drilling there are a variety of functions and characteristics that are expected of drilling fluids, also known as drilling muds, or simply “muds”. The drilling fluid should carry cuttings from beneath the bit, transport them through the annulus, and allow their separation at the surface while at the same time the rotary bit is cooled and cleaned. A drilling mud is also intended to reduce friction between the drill string and the sides of the hole, while maintaining the stability of uncased sections of the borehole. The drilling fluid is formulated to prevent unwanted influxes of formation fluids from permeable rocks penetrated and often to form a thin, low permeability filter cake that temporarily seals pores, other openings, and formations penetrated by the drill bit. The drilling fluid may also be used to collect and interpret information available from drill cuttings, cores and electrical logs. It will be appreciated that within the scope of the claimed invention herein, the term “drilling fluid” also encompasses “drill-in fluids” and “completion fluids”.

Drilling fluids are typically classified according to their base fluid. In water-based muds, solid particles are suspended in water or brine. Oil can be emulsified in the water. Nonetheless, the water is the continuous phase. Brine-based drilling fluids, of course are a water-based mud (WBM) where the aqueous component is brine. Oil-based muds (OBM) are the opposite or inverse. Solid particles are suspended in oil, and water or brine is emulsified in the oil; therefore, the oil is the continuous phase. Oil-based muds can be either all-oil based or water-in-oil macroemulsions, which are also called invert emulsions. In oil-based mud the oil may consist of any oil that may include, but is not limited to, diesel, mineral oil, esters, or alpha-olefins, natural oils, derivatives thereof, and combinations thereof.

It is apparent to those selecting or using a drilling fluid for oil and/or gas exploration that an essential component of a selected fluid is that it be properly balanced to achieve the necessary characteristics for the specific end application. Because drilling fluids are called upon to perform a number of tasks simultaneously, this desirable balance is not always easy to achieve.

Filter cakes are the residues deposited on a permeable medium, such as a formation surface, when a slurry, emulsion or suspension (e.g. a drilling fluid) is forced against the medium under pressure. Filtrate is the liquid that passes through the medium, leaving the cake deposited on the surface of the medium. Filter cake properties, such as cake thickness, toughness, slickness and permeability are important because the filter cake that forms on permeable zones in a wellbore can cause stuck pipe and other drilling problems. Reduced hydrocarbon production may result from reservoir or skin damage when a poor filter cake allows deep filtrate invasion. In some cases, a certain degree of filter cake buildup is desirable to isolate formations from drilling fluids. In open hole completions in high-angle or horizontal holes, the formation of an external filter cake is preferable to a cake that forms partly inside the formation (internal). The latter has a higher potential for formation damage.

It will be appreciated that in the context of this invention the term “filter cake” includes any oil, emulsion or invert emulsion part of the filter cake, and that the filter cake is defined herein as a combination of any added solids, if any, and drilled solids with the drilling fluid. It will also be understood that the drilling fluid, e.g. OBM is concentrated at the borehole face and partially inside the formation. Further, an open hole completion is understood to be a well completion that has no liner or casing set across the reservoir formation, thus allowing the produced fluids to flow directly into the wellbore. A liner or casing may be present in other intervals, for instance between the producing interval and the surface.

Many operators are interested in improving formation clean up after drilling into reservoirs with OBMs. More efficient filter cake and formation clean up is desired. Skin damage removal from internal and external filter cake deposition during oil well reservoir drilling with oil-based drill-in and drilling fluids is desirable to maximize hydrocarbon recovery.

It would be desirable if compositions and methods could be devised to aid and improve the ability to clean up filter cake, and to remove it more completely, without causing additional formation damage.

### SUMMARY

There is provided, in one form, a method for cleaning oil-based mud (OBM) filter cake in which a treatment composition is contacted with the filter cake and in which a portion of filter cake particles or oil from the filter cake is transferred into the treatment composition. The treatment composition may include, but is not limited to, a surfactant, an aqueous-based fluid, an agent, and combinations thereof. The surfactant may be or include, but is not limited to nonionic surfactants, anionic surfactants, cationic surfactants, amphoteric surfactants, zwitterionic surfactants, extended chain surfactants, dendritic surfactants, dendritic extended surfactants, and combinations thereof. The agent may be a polycarboxylic diacid, such as [N-(1,2-dicarboxyethylene)-D,L-asparagine acid] (IDS), polyaspartic acid (DS), ethylenediamine-disuccinic acid (EDDS), [N,N-bis(carboxylmethyl)L-glutamic acid] (GLDA), methylglycinediacetic acid (MGDA), salts thereof, derivatives thereof, and combinations thereof.

There is provided, in another non-limiting embodiment, a method of cleaning oil-based mud (OBM) filter cake particles from a hydrocarbon reservoir. The method may include contacting an OBM filter cake formed over at least part of a wellbore with a treatment composition, and incorporating at least a portion of the oil from the filter cake particles into the treatment composition. The treatment composition may have or include, but is not limited to a surfactant, an aqueous-based fluid, a solubilizing agent, a second acid, and combinations thereof. The surfactant may be or include nonionic surfactants, anionic surfactants, cationic surfactants, amphoteric surfactants, zwitterionic surfactants, extended chain surfactants, dendritic surfactants, dendritic extended surfactants, and combinations thereof. The solubilizing agent may be or include long chain alcohols, phenol derivatives, fatty esters, a first acid, and combinations thereof. The first acid may be or include citric acid, oleic acid, tartaric acid, stearic acid, linoleic or linolenic acid, aromatic dicarboxylic acids, oxalic acid, malonic acid, succinic acid, glutaric acid, glutamic acid, boric acid, adipic acid, a diacid (e.g. polycarboxylic diacid), a triacid, a tetraacid, and combinations thereof. The second acid may be or include organic acids, inorganic acids, and combinations thereof.

In an alternative non-limiting embodiment of the method, the method may be or include contacting an OBM filter cake formed over at least part of a wellbore with a treatment composition, and incorporating at least a portion of filter cake particles into the treatment composition. The filter cake particles may be or include, but are not limited to, calcium carbonate, hematite, ilmenite, manganese tetroxide, manganous oxide, iron carbonate, magnesium oxide, barium sulfate, salts thereof, and mixtures thereof.

The treatment composition used for cleaning the oil-based mud (OBM) filter cake appears to better incorporate oil and/or filter cake particles into the treatment composition as compared to an otherwise identical filter cake absent the treatment composition.

### DETAILED DESCRIPTION

It has been discovered that a treatment composition may be used to clean oil-based mud (OBM) filter cake particles from a hydrocarbon reservoir by contacting an OBM filter cake formed over at least part of a wellbore with a treatment composition, incorporating at least a portion of the oil from the filter-cake into the treatment composition, incorporating at least a portion of the filter cake particles into the treatment composition, and combinations thereof. The treatment composition may have or include, but is not limited to, a surfactant, an aqueous-based fluid, an agent, and combinations thereof. “Oil-based filter cake” is defined herein to be a substantially hydrophobic filter cake, e.g. crude oil, paraffins, asphaltenes, condensate, surfactants, and the like. ‘Substantially’ is defined herein to mean greater than 50% of the filter cake includes hydrophobic components.

The surfactant within the treatment fluid composition and/or the oil-based filter cake may be or include, but is not limited to nonionic surfactants, anionic surfactants, cationic surfactants, amphoteric surfactants, gemini surfactants, zwitterionic surfactants, extended chain surfactants, dendritic surfactants, dendritic extended surfactants, and combinations thereof. The nonionic surfactants may be or include, but are not limited to, alkyl polyglycosides, sorbitan esters, amine ethoxylates, diamine ethoxylates, methyl glucoside esters, polyglycerol esters, alkyl ethoxylates, alcohols that have been polypropoxylated and polyethoxylated, alcohols that have been polypropoxylated, alcohols that have been polyethoxylated. The anionic surfactants may be or include, but are not limited to, alkali metal alkyl sulfates, alkyl or alkylaryl sulfonates, linear or branched alkyl ether sulfates and sulfonates, alcohol polypropoxylated and polyethoxylated sulfates, alcohol polypropoxylated sulfates, alcohol polyethoxylated sulfates, alkyl or alkylaryl disulfonates, alkyl disulfates, alkyl sulphosuccinates, alkyl ether sulfates, linear and branched ether sulfates. The cationic surfactants may be or include, but are not limited to, arginine methyl esters, alkanolamines, and alkylenediamines, and mixtures thereof.

“Extended chain surfactants” are defined herein to be surfactants having propoxylated/ethoxylated spacer arms. The extended chain surfactants are intramolecular mixtures having at least one hydrophilic portion and at least one lipophilic portion with an intermediate polarity portion in between the hydrophilic portion and the lipophilic portion; the intermediate polarity portion may be referred to as a spacer. They attain high solubilization in the mesophase fluids (e.g. single phase microemulsions), are in some instances insensitive to temperature and are useful for a wide variety of oil types, such as natural or synthetic polar oil types in a non-limiting embodiment. More information related to extended chain surfactants may be found in U.S. Pat. No. 8,235,120, which is herein incorporated by reference in its entirety. A “dendritic surfactant” may have at least two lipophilic chains that have been joined at a hydrophilic center and have a branch-like appearance. A “dendritic extended surfactant” as defined herein may have a hydrophilic center and at least two lipophilic chains where at least one of the lipophilic chains has a spacer arm. The dendritic surfactant and dendritic extended surfactant are further explained in U.S. Patent Application No. 2012/0241220, which is herein incorporated by reference in its entirety.

In an alternative embodiment, the treatment composition may include an optional additional component, such as a co-surfactant, a corrosion inhibitor, a second acid different from the first acid, an oil-based fluid, a solvent, a chelant, and combinations thereof. However, in one non-limiting embodiment, the treatment composition does not include the oil-based fluid, the solvent, or combinations thereof. The co-surfactant may be or include, but is not limited to, alcohols, glycols, ethoxylated alcohols, ethoxylated glycols, ethoxylated phenols, propoxylated alcohols, propoxylated glycols, propoxylated phenols, ethoxylated and propoxylated alcohols, ethoxylated and propoxylated glycols, ethoxylated and propoxylated phenols, and combinations thereof.

The agent may be or include, but is not limited to, long chain alcohols, phenol derivatives, fatty esters, a first acid, and combinations thereof. The first acid may be or include citric acid, oleic acid, tartaric acid, stearic acid, linoleic acid, linolenic acid, aromatic dicarboxylic acids, oxalic acid, malonic acid, succinic acid, glutaric acid, glutamic acid, boric acid, adipic acid, a diacid, a triacid, a tetraacid, and combinations thereof. The long chain alcohol may be any alcohol having at least 8 carbons. The phenol derivatives may be or include, but are not limited to alkyl phenol ethoxylate, alkyl phenol salts, and combinations thereof. The diacid may be a polycarboxylic diacid, such as but not limited to [N-(1,2-dicarboxyethylene)D,L asparagine acid] (IDS), polyaspartic acid (DS), ethylenediamine-disuccinic acid (EDDS), [N,N-bis(carboxylmethyl)L-glutamic acid] (GLDA), methylglycinediacetic acid (MGDA), salts thereof, derivatives thereof, and combinations thereof. The tetraacid may be ethylenediaminetetraacetic acid (EDTA), hydroxyl-ethylenediaminetetraacetic acid (HEDTA), and the like.

The concentration of the agent within the total treatment composition may range from about 0.5 vol % independently to about 30 vol %. Although the inventors do not wish to be limited to a particular theory, it is thought that at lower concentrations (e.g. 1 vol % independently to about 5 vol %) within the treatment composition, the agent may function as a clinker′ and thereby may allow the treatment composition to better solubilize oil from the OBM filter cake and stabilize the treatment composition. Alternatively, at higher concentrations (e.g. 10 vol % independently to about 30 vol %), it is thought that the agent may allow the treatment composition to better incorporate filter cake particles. As used herein with respect to a range, “independently” means that any lower threshold may be used together with any upper threshold to give a suitable alternative range.

When the goal of the treatment composition is to solubilize and incorporate oil from the filter cake into the treatment composition, it may be beneficial for the treatment composition to include the optional second acid. When the goal of the treatment composition is to incorporate the filter cake particles into the treatment composition, the treatment composition may include the optional second acid, but the second acid is not necessary. The second acid may be or include, but is not limited to, formic acid, acetic acid, hydrochloric acid, citric acid, and combinations thereof. In a non-limiting embodiment, the second acid is not included in the treatment acid.

When the treatment composition incorporates the filter cake particles, there is less precipitation of insoluble solids from the treatment composition as compared to an otherwise identical method absent the treatment composition. The filter cake particles may be or include, but are not limited to, calcium carbonate, hematite, ilmenite, manganese tetroxide, manganous oxide, iron carbonate, magnesium oxide, barium sulfate, salts thereof, and mixtures thereof. In one non-limiting example, the calcium carbonate filter cake particles may be incorporated into the treatment composition, but fewer insoluble calcium solids would precipitate from the treatment composition.

In one non-limiting embodiment, the treatment composition may be a dispersion, a suspension, a microemulsion, a single phase microemulsion or an emulsion. Non-limiting examples of the emulsion may be or include a macroemulsion, a nanoemulsion, a miniemulsion, and combinations thereof. The treatment composition may be generated at the surface prior to contacting the OBM filter cake with the treatment composition, or the treatment composition may be generated in situ downhole, e.g. when contacting the OBM filter cake with the treatment composition. The oil-based fluids and filter cake may be contacted with at least one surfactant, the aqueous-based fluid, an agent, and an optional second acid to form the emulsion. Such an in situ emulsion may incorporate at least a portion of the oil from within the filter cake, filter cake particles, and combinations thereof into the emulsion. A more detailed explanation related to the use of in situ fluid formulations for cleaning oil or synthetic based muds may be found in U.S. Pat. No. 8,091,645, which is herein incorporated by reference in its entirety.

A ‘linker agent’ is defined herein to be a lipophilic or hydrophilic additive that may increase the solubilization and modify the interfacial properties of the treatment composition (e.g. a microemulsion). The linker agent may be an amphiphile molecule that segregates and interact near the interface of the hydrophobic tail (e.g. when the linker agent is lipophilic), or the surfactant head (e.g. when the linker agent is hydrophilic), thereby affecting the packing and structural assembly of surfactants at the interface to increase the transitional zone thickness. A lipophilic linker agent in the oil phase of an emulsion may orient along the surfactant tails and promote lipophilic interaction and thus incorporation of oil molecules from the filter cake into the oil phase of the emulsion. A hydrophilic linker agent may increase the interactions between surfactant molecules and a water-based fluid and allow for a more flexible surfactant membrane, thereby leading to a better performance of a microemulsion solubilization. A linker agent may be made compatible with a chelating agent (where the agent functions to incorporate filter cake particles into the treatment composition), but the overall goal of the treatment composition may vary, as well as how the agent functions within the treatment composition.

The treatment composition may remain stable at a temperature up to about 450° F. (about 233° C.), alternatively the temperature of the treatment composition may range from about 70° F. (about 21° C.) independently to about 350° F. (about 176° C.). The treatment composition may have a pH less than about 5, or the pH may range from about 0.5 independently to about 4 in another non-limiting embodiment. Alternatively, the pH may range from about 0.5 independently to about 2, or the pH may be less than about 1.

The aqueous-based fluid may be or include a fresh water fluid, a seawater fluid, a brine-based fluid, and mixtures thereof. The brine-based fluid may be or include, but is not limited to monovalent brines, divalent brines, and mixtures thereof. Alternatively, the brine-based fluid may be or include potassium chloride, sodium chloride, calcium chloride, zinc bromide, cesium formate, potassium formate, sodium formate, sodium bromide, cesium bromide, calcium bromide, sodium, potassium, cesium, lithium, ammonium, alkyl ammonium, calcium, magnesium, barium, aluminum, fluoride, chloride, bromide, iodide, sulfate, carbonate, phosphate, formate, acetate, and combinations thereof.

In the foregoing specification, the invention has been described with reference to specific embodiments thereof, and has been described as effective in providing methods and compositions for incorporating oil and/or filter cake particles from a filter cake into a treatment composition. However, it will be evident that various modifications and changes can be made thereto without departing from the broader spirit or scope of the invention as set forth in the appended claims. Accordingly, the specification is to be regarded in an illustrative rather than a restrictive sense. For example, specific aqueous fluids, surfactants, agents, second acids, co-surfactants, polycarboxylic diacids, and corrosion inhibitors falling within the claimed parameters, but not specifically identified or tried in a particular composition or method, are expected to be within the scope of this invention. In a non-limiting embodiment, the cosurfactant may be a hydrotrope cosurfactant, i.e. having the ability to be water-soluble and avoid precipitation.

The present invention may suitably comprise, consist or consist essentially of the elements disclosed and may be practiced in the absence of an element not disclosed. For instance, the treatment composition may consist of or consist essentially of a surfactant, an aqueous-based fluid, an agent, and combinations thereof; the surfactant may be or include nonionic surfactants, anionic surfactants, cationic surfactants, amphoteric surfactants, zwitterionic surfactants, extended chain surfactants, dendritic surfactants, dendritic extended surfactants, gemini surfactants, and combinations thereof; the agent may be or include long chain alcohols, phenol derivatives, fatty esters, a first acid, and combinations thereof; the first acid may be or include citric acid, oleic acid, tartaric acid, stearic acid, linoleic acid, linolenic acid, aromatic dicarboxylic acids, oxalic acid, malonic acid, succinic acid, glutaric acid, glutamic acid, boric acid, adipic acid, a diacid, a triacid, a tetraacid, and combinations thereof.

The method of cleaning oil-based mud (OBM) filter cake particles from a hydrocarbon reservoir may consist of or consist essentially of contacting an OBM filter cake formed over at least part of a wellbore with a treatment composition, and incorporating at least a portion of the oil from the filter-cake particles into the treatment composition; alternatively, the method may consist of or consist essentially of contacting an OBM filter cake formed over at least part of a wellbore with a treatment composition, and incorporating at least a portion of the filter cake particles into the treatment composition, and combinations thereof.

The words “comprising” and “comprises” as used throughout the claims, are to be interpreted to mean “including but not limited to” and “includes but not limited to”, respectively.

What is claimed is:

1. A method for cleaning oil-based mud (OBM) filter cake, the method comprising:
contacting the OBM filter cake with a treatment composition, wherein the treatment composition comprises:
a surfactant selected from the group consisting of nonionic surfactants, anionic surfactants, cationic surfactants, amphoteric surfactants, zwitterionic surfactants, gemini surfactants, extended chain surfactants, dendritic surfactants, dendritic extended surfactants, and combinations thereof;
an aqueous-based fluid; and
an agent for cleaning filter cake particles or cleaning oil from the oil-based mud (OBM) filter cake, the agent comprising a first acid that is selected from the group consisting of [N-(1,2-dicarboxyethylene)-D,L-asparagine acid] (IDS), polyaspartic acid (DS), ethylenediamine-disuccinic acid (EDDS), [N,N-bis(carboxylmethyl)L-glutamic acid] (GLDA), methylglycinediacetic acid (MGDA), salts thereof, derivatives thereof, and combinations thereof, and
transferring a portion of the oil and/or a portion of the filter cake particles into the treatment composition.

2. The method of claim 1, wherein the treatment composition further comprises a linker agent for increasing solubilization or modifying the interfacial properties of the treatment composition.

3. The method of claim 1, wherein the treatment composition further comprises an additional component selected from the group consisting of a co-surfactant, a corrosion inhibitor, a second acid different from the first acid, a chelant, and combinations thereof.

4. The method of claim 3, wherein the co-surfactant is selected from the group consisting of alcohols, glycols, ethoxylated alcohols, ethoxylated glycols, ethoxylated phenols, propoxylated alcohols, propoxylated glycols, propoxylated phenols, ethoxylated and propoxylated alcohols, ethoxylated and propoxylated glycols, ethoxylated and propoxylated phenols, and combinations thereof.

5. The method of claim 3, wherein the treatment composition comprises the second acid and the second acid is selected from the group consisting of formic acid, acetic acid, hydrochloric acid, citric acid, and combinations thereof.

6. The method of claim 5, wherein the concentration of the second acid ranges from about 5 vol % to about 30 vol % of the total treatment composition.

7. The method of claim 1, wherein the concentration of the agent ranges from about 0.5 vol % to about 5 vol % of the total treatment composition.

8. The method of claim 1, wherein the concentration of the surfactant ranges from about 5 vol % to about 30 vol % of the total treatment composition.

9. The method of claim 1, wherein the treatment composition does not include an oil-based fluid, a solvent, or combinations thereof.

10. The method of claim 1, wherein the treatment composition has less precipitation of insoluble solids as compared to an otherwise identical treatment composition absent the agent.

11. The method of claim 1, wherein the treatment composition remains stable at a temperature up to about 400° F. (about 204° C.).

12. The method of claim 1, wherein the pH of the treatment composition is less than about 5.

13. The method of claim 1, wherein the aqueous-based fluid is selected from the group consisting of a fresh water fluid, a seawater fluid, a brine-based fluid, and mixtures thereof.

14. A method of cleaning oil-based mud (OBM) filter cake particles from a hydrocarbon reservoir comprising:
contacting an OBM filter cake formed over at least part of a wellbore with a treatment composition comprising a surfactant, a second acid, an aqueous-based fluid, a solubilizing agent, and combinations thereof; wherein the surfactant is selected from the group consisting of nonionic surfactants, anionic surfactants, cationic surfactants, amphoteric surfactants, gemini surfactants, zwitterionic surfactants, extended chain surfactants, dendritic surfactants, dendritic extended surfactants, and combinations thereof; wherein the second acid is selected from the group consisting of organic acids, inorganic acids, and combinations thereof; and wherein the solubilizing agent is selected from the group consisting of [N-(1,2-dicarboxyethylene)-D,L-asparagine acid] (IDS), polyaspartic acid (DS), ethylenediamine-disuccinic acid (EDDS), [N,N-bis(carboxylmethyl)L-glutamic acid] (GLDA), methylglycinediacetic acid (MGDA), salts thereof, derivatives thereof, and combinations thereof; and
incorporating at least a portion of the oil from the filter-cake into the treatment composition.

15. The method of claim 14, wherein the concentration of the solubilizing agent ranges from about 0.5 vol % to about 5 vol % of the total treatment composition.

16. The method of claim 15, wherein more oil is incorporated from the filter cake as compared to an otherwise identical filter cake absent the treatment composition.

17. The method of claim 14, further comprising generating the treatment composition in situ downhole when contacting the OBM filter cake with the treatment composition.

18. The method of claim 14, wherein the filter cake particles are selected from the group consisting of calcium carbonate, hematite, ilmenite, manganese tetroxide, manganous oxide, iron carbonate, magnesium oxide, barium sulfate, salts thereof, and mixtures thereof.

19. A method of cleaning oil-based mud (OBM) filter cake particles from a hydrocarbon reservoir comprising:
contacting an OBM filter cake formed over at least part of a wellbore with a treatment composition comprising a surfactant, an aqueous-based fluid, an agent in a concentration ranging from about 5 vol % to about 30 vol %, and combinations thereof; wherein the surfactant is selected from the group consisting of nonionic surfactants, anionic surfactants, cationic surfactants, amphoteric surfactants, gemini surfactants, zwitterionic surfactants, extended chain surfactants, dendritic surfactants, dendritic extended surfactants, and combinations thereof; and wherein the agent is selected from the group consisting of [N-(1,2-dicarboxyethylene)-D,L-asparagine acid] (IDS), polyaspartic acid (DS), ethylenediamine-disuccinic acid (EDDS), [N, N-bis(carboxylmethyl)L-glutamic acid] (GLDA), methylglycinediacetic acid (MGDA), salts thereof, derivatives thereof, and combinations thereof; and
incorporating at least a portion of filter cake particles into the treatment composition, wherein the filter cake particles are selected from the group consisting of calcium carbonate, hematite, ilmenite, manganese tetroxide, manganous oxide, iron carbonate, magnesium oxide, barium sulfate, salts thereof, and mixtures thereof.
